(19) United States
(12) Patent Application Publication
(10) Pub. No.: US 2007/0005966 A1
(43) Pub. Date: Jan. 4, 2007

(54) Derivation of a shared keystream from a shared secret

(76) Inventors: Selim Aissi, Beaverton, OR (US); Mrudula Yelamanchi, Portland, OR (US); Sameer Abhinkar, Beaverton, OR (US); Scott Blum, Beaverton, OR (US); Jane Dashevsky, Beaverton, OR (US); Abhay Dharmadhikari, Beaverton, OR (US); Benjamin J. Matasar, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/174,132

(22) Filed: Jun. 30, 2005

(51) Int. Cl. H04L 9/00

(52) U.S. Cl. 713/168

(57) ABSTRACT

Techniques and architectures that allow two electronic devices to derive a shared keystream from a shared secret. In one embodiment, each of the electronic devices generates a random number and transmits the random number to the other electronic device. Each electronic device may generate value by performing a hash on the shared secret and the two random numbers. The hash value may be used to generate a shared keystream.

### TECHNICAL FIELD

Embodiments of the invention relate to security in electronic systems. More particularly, embodiments of the invention relate to techniques for shared key encryption for use with two or more electronic systems.

### BACKGROUND

Many techniques currently exist to exchange information between electronic devices in a secure manner. One common technique is the use of public/private key pairs. A public key infrastructure (PKI) allows users of electronic systems to securely exchange information using an unsecured network such as, for example, the Internet. A PKI operates using a private and public key pair that is exchanged using a trusted authority.

One disadvantage to the current PKI techniques is that one or more third-party authorities (e.g., certificate authority, registration authority) as well as public directories are required. Maintenance of this infrastructure can be complex. Further, implementation of PKI protocols on an endpoint with limited resources may be impractical.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of electronic devices coupled to communicate via a network.

FIG. 2 is a flow diagram of an interaction between two electronic devices that communicate to derive a shared keystream from a shared secret.

FIG. 3 is a block diagram of one embodiment of an electronic system.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Described herein are techniques and architectures that allow two electronic devices to derive a shared keystream from a shared secret. In one embodiment, each of the electronic devices generates a random number and transmits the random number to the other electronic device. Each electronic device may generate value by performing a hash on the shared secret and the two random numbers. The hash value may be used to generate a shared keystream.

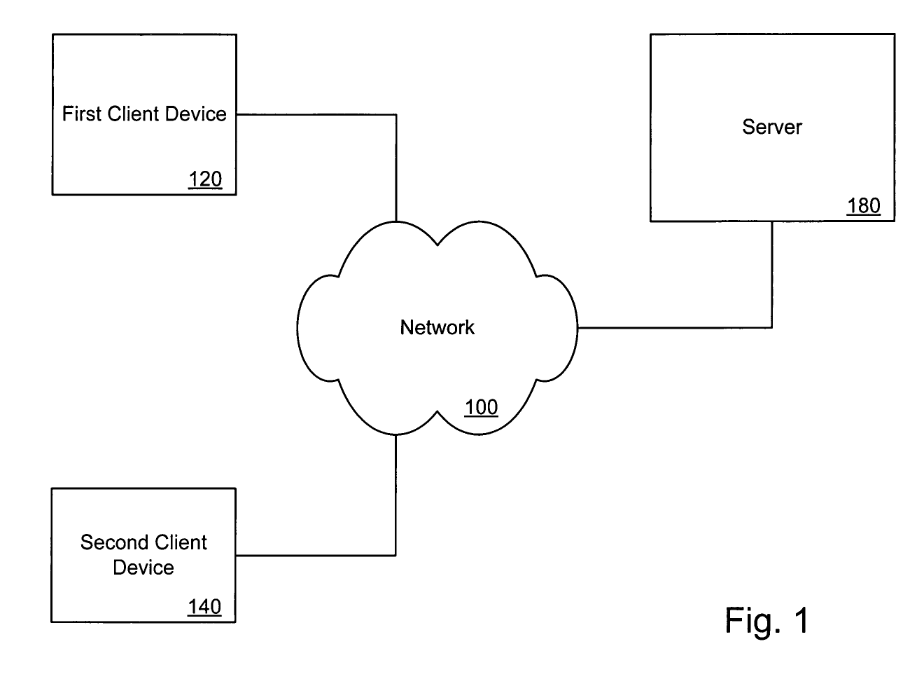

FIG. 1 is a block diagram of electronic devices coupled to communicate via a network. Network 100 may be any type of network including an unsecured network such as, for example, the Internet. Because the techniques described herein allow two electronic devices to communicate in a secure manner without use of trusted authorities, network 100 is not required to provide any security infrastructure.

The example of FIG. 1 illustrates two client electronic devices 120 and 140 that may communicate with a server 180 via network 100. Any of the network devices may communicate with any other of the network devices in a secure manner using the shared secret technique described herein. For example, client device 120 and client device 140 may independently interact with server 180 in a secure manner using the techniques described herein. Similarly, client device 120 and client device 140 may interact in a secure manner using the techniques described herein.

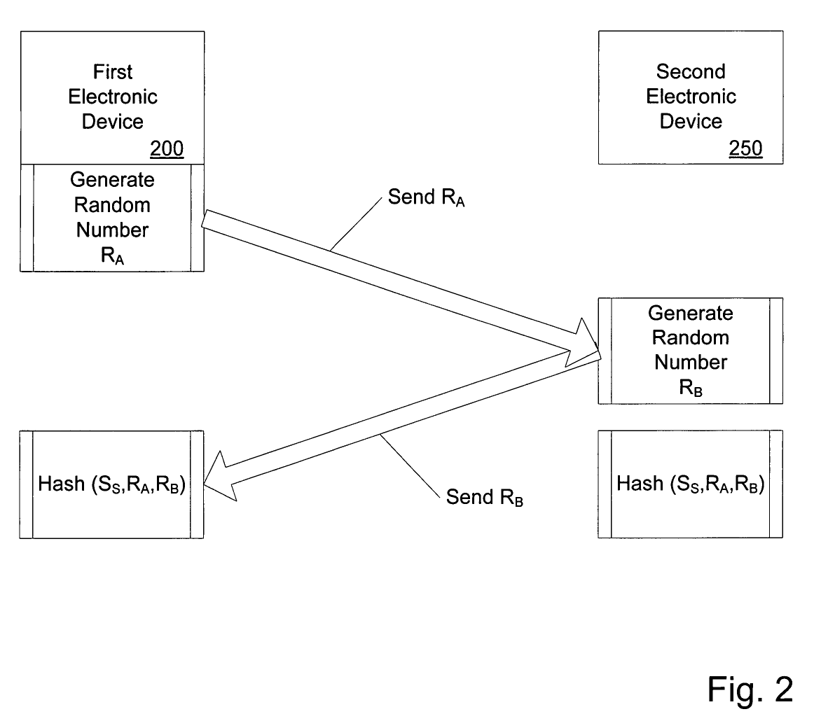

FIG. 2 is a flow diagram of an interaction between two electronic devices that communicate to derive a shared keystream from a shared secret. The technique described herein differs from previous key derivations in that key derivation as described herein may be accomplished using only a block cipher, a cryptographic hash, a shared secret and a random number generator. Most current key derivation mechanisms rely upon a public key infrastructure as the root of trust. The technique described herein, the root of trust is a shared secret. Therefore, no trusted authority is needed.

The description herein refers to two random numbers. In one embodiment, the two random numbers are generated by known random number generators and are not necessarily random in the pure mathematical sense. However, the numbers are sufficiently random to provide security using the techniques described herein.

First electronic device 200 and second electronic device 250 may be separate execution environments, for example, two mobile computer systems or different execution environments in a single electronic device. In one embodiment, the two execution environments use a common block cipher encryption algorithm, for example, AES and use a common cryptographic hash algorithm, for example, SHA-1.

AES is the Advanced Encryption Standard, which is an encryption technique that is described in greater detail in Federal Information Processing Standard 197, approved on Dec. 6, 2001 and available from the United States Commerce Department. SHA-1 is a secure hash function that produces a hash that is 160 bits long and in commonly used in the art. Subsequent hash functions, for example, SHA-2 may also be used. While specific algorithms (AES and SHA-1) are cited here, other comparable algorithms may be used so long as both first electronic device 200 and second electronic device 250 use the same algorithms.

In order to engage in secure communications, first electronic device 200 and second electronic device 250 share a secret, labeled S_{S} in FIG. 2. In one embodiment, first electronic device 200 and second electronic device 250 may perform a challenge/response operation to verify the shared secret S_{S}. In one embodiment, first electronic device 200 may generate a random number R_{A} and may transmit the random number to second electronic device 250. Similarly, second electronic device 250 may generate a random number R_{B}. Second electronic device 250 may transmit R_{B} to first electronic device 200.

In response to receiving the random numbers each of first electronic device 200 and second electronic device 250 have S_{S}, R_{A} and R_{B}. Each device may perform a hash operation on S_{S}, R_{A} and R_{B}. The hash may be performed, for example, using SHA-1, SHA-2 or another hash algorithm. The result of the operation, Z, may be used to generate the shared keystream.

In one embodiment, in order to generate the keystream, the block cipher (e.g., AES) may be used in counter mode, which turns a block cipher into a stream cipher. The details of counter mode are known in the art and may require a key with an initialization vector. In one embodiment, Z may be split into two components that are used for the key and the initialization vector. In this way, through use of the counter mode, a shared keystream of arbitrary size may be generated between first electronic system 200 and second electronic system 250.

For example, using 128-bit AES, SHA-1 and AES counter mode:

Z=SHA-1(S_{S}, R_{A}, R_{B})

where Z is a 160-bit result. The first 128 bits from Z may be used as the shared key, K, and the last 32 bits of Z may be used as the most significant bits of the initialization vector I_{VEC}. These numbers are used to seed the AES counter mode that may be used to generate a keystream of arbitrary length.

Thus, the technique described with respect to FIG. 2 is a relatively simple and computationally light-weight technique that may be implemented on many different types of electronic devices including, for example, desktop computer systems, mobile computer systems, cellular telephones including “smart” phones, kiosks, personal digital assistants (PDAs), and other electronic systems capable of communicating with other systems via wired and/or wireless media. Further, interaction with a trusted third party is not required, which may simplify implementation as well as operation as compared to previous techniques.

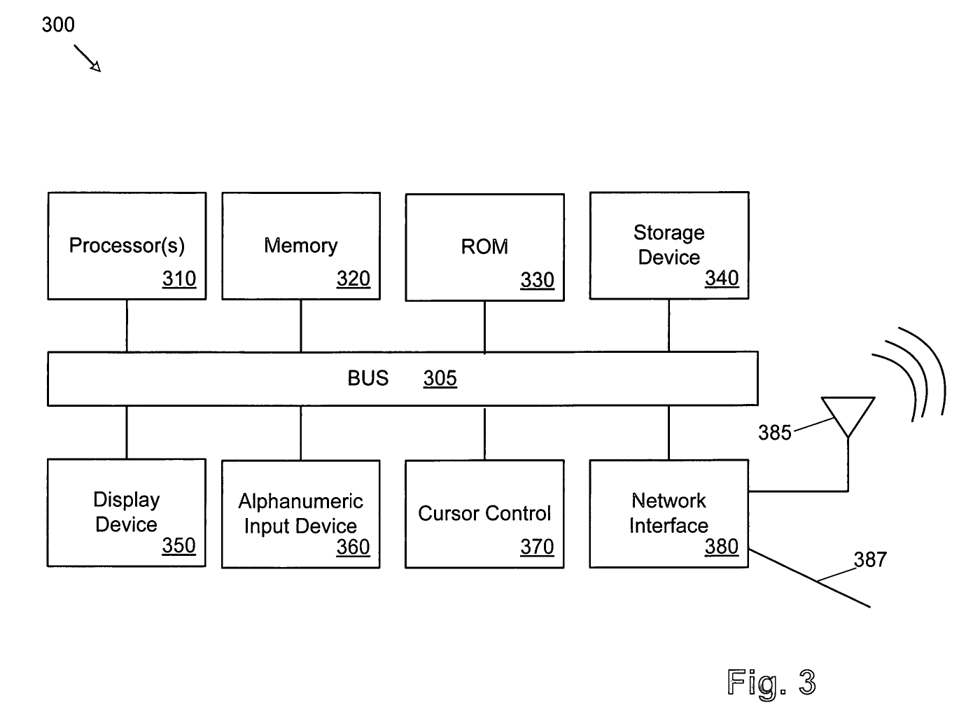

FIG. 3 is a block diagram of one embodiment of an electronic system. The electronic system illustrated in FIG. 3 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components. FIG. 3 may represent either one or both of the electronic devices engaged in the interaction described above.

Electronic system 300 includes bus 305 or other communication device to communicate information, and processor 310 coupled to bus 305 that may process information. While electronic system 300 is illustrated with a single processor, electronic system 300 may include multiple processors and/or co-processors. Electronic system 300 further may include random access memory (RAM) or other dynamic storage device 320 (referred to as main memory), coupled to bus 305 and may store information and instructions that may be executed by processor 310. Main memory 320 may also be used to store temporary variables or other intermediate information during execution of instructions by processor 310.

Electronic system 300 may also include read only memory (ROM) and/or other static storage device 330 coupled to bus 305 that may store static information and instructions for processor 310. Data storage device 340 may be coupled to bus 305 to store information and instructions. Data storage device 340 such as a magnetic disk or optical disc and corresponding drive may be coupled to electronic system 300.

Electronic system 300 may also be coupled via bus 305 to display device 350, such as a cathode ray tube (CRT) or liquid crystal display (LCD), to display information to a user. Alphanumeric input device 360, including alphanumeric and other keys, may be coupled to bus 305 to communicate information and command selections to processor 310. Another type of user input device is cursor control 370, such as a mouse, a trackball, or cursor direction keys to communicate direction information and command selections to processor 310 and to control cursor movement on display 350.

Electronic system 300 further may include network interface(s) 380 to provide access to a network, such as a local area network. Network interface(s) 380 may include, for example, a wireless network interface having antenna 385, which may represent one or more antenna(e). Network interface(s) 380 may also include, for example, a wired network interface to communicate with remote devices via network cable 387, which may be, for example, an Ethernet cable, a coaxial cable, a fiber optic cable, a serial cable, or a parallel cable.

In one embodiment, network interface(s) 380 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 380 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
generating a result value using a hash operation on a shared secret value and two random numbers, wherein a first of the two random numbers is received from a remote computing environment and a second of the two random numbers is transmitted to the remote computing environment; and
generating a keystream based, at least in part, on a shared key including a first portion of the result value and an initialization vector including a second portion of the result value.

2. The method of claim 1 further comprising communicating with the remote computing environment using the keystream.

3. The method of claim 1 wherein the two random numbers comprise a first random number generated in a first computing environment and a second random number generated in a second computing environment.

4. The method of claim 3 wherein the first computing environment comprises a first electronic system and the second computing environment comprises a second electronic system, and further wherein the first electronic system and the second electronic system are configured to communicate using network protocols.

5. The method of claim 3 wherein the first computing environment and the second computing environment both exist on a single electronic system and operate independently of each other.

6. The method of claim 1 wherein the hash operation comprises a Secure Hash Algorithm (SHA-x) standard operation.

7. The method of claim 1 wherein the first portion comprises 128 bits.

8. The method of claim 1 wherein the second portion comprises 32 bits.

9. The method of claim 1 wherein generating the keystream based, at least in part, on the shared key and the initialization vector comprises performing a block cipher algorithm in counter mode using the shared key and the initialization vector.

10. The method of claim 9 wherein the block cipher algorithm comprises an Advanced Encryption Standard (AES) algorithm.

11. An article comprising a computer-readable medium having stored thereon instructions that, when executed, cause one or more processors to:
generate a result value using a hash operation on a shared secret value and two random numbers, wherein a first of the two random numbers is received from a remote computing environment and a second of the two random numbers is transmitted to the remote computing environment; and
generate a keystream based, at least in part, on a shared key including a first portion of the result value and an initialization vector including a second portion of the result value.

12. The article of claim 11 further comprising instructions that, when executed, cause the one or more processors to communicate with the remote computing environment using the keystream.

13. The article of claim 11 wherein the two random numbers comprise a first random number generated in a first computing environment and a second random number generated in a second computing environment.

14. The article of claim 13 wherein the first computing environment comprises a first electronic system and the second computing environment comprises a second electronic system, and further wherein the first electronic system and the second electronic system are configured to communicate using network protocols.

15. The article of claim 13 wherein the first computing environment and the second computing environment both exist on a single electronic system and operate independently of each other.

16. The article of claim 11 wherein the hash operation comprises a Secure Hash Algorithm (SHA-x) standard operation.

17. The article of claim 11 wherein the first portion comprises 128 bits.

18. The article of claim 11 wherein the second portion comprises 32 bits.

19. The article of claim 11 wherein generating the keystream based, at least in part, on the shared key and the initialization vector comprises performing a block cipher algorithm in counter mode using the shared key and the initialization vector.

20. The article of claim 19 wherein the block cipher algorithm comprises an Advanced Encryption Standard (AES) algorithm.

21. An apparatus comprising:
a random number generator to generate a random number, R_{A};
a network interface coupled with the random number generator to transmit R_{A} to a remote electronic device and to receive a random number R_{B} from the remote electronic device; and
processing circuitry coupled with the network interface to perform a hash operation on R_{A}, R_{B} and a shared secret value S_{S} to generate a result value, the processing circuitry further to perform a block cipher algorithm in counter mode to generate a keystream based, at least in part, on a shared key including a first portion of the result value and an initialization vector including a second portion of the result value.

22. The apparatus of claim 21 wherein the hash operation comprises a Secure Hash Algorithm (SHA-x) standard operation.

23. The apparatus of claim 21 wherein the first portion comprises 128 bits and the second portion comprises 32 bits.

24. The apparatus of claim 21 wherein the block cipher algorithm comprises an Advanced Encryption Standard (AES) algorithm.

25. A system comprising:
a random number generator to generate a random number, R_{A};
a network interface coupled with the random number generator to transmit R_{A} to a remote electronic device and to receive a random number R_{B} from the remote electronic device;
a network cable connected to the network interface; and
processing circuitry coupled with the network interface to perform a hash operation on R_{A}, R_{B} and a shared secret value S_{S} to generate a result value, the processing circuitry further to perform a block cipher algorithm in counter mode to generate a keystream based, at least in part, on a shared key including a first portion of the result value and an initialization vector including a second portion of the result value.

26. The system of claim 25 wherein the hash operation comprises a Secure Hash Algorithm (SHA-x) standard operation.

27. The system of claim 25 wherein the first portion comprises 128 bits and the second portion comprises 32 bits.

28. The system of claim 25 wherein the block cipher algorithm comprises an Advanced Encryption Standard (AES) algorithm.
